(19) United States
(12) Patent Application Publication
(10) Pub. No.: US 2020/0302592 A1
(43) Pub. Date: Sep. 24, 2020

(54) METHOD AND APPARATUS FOR PROVIDING DATA AND INSPECTING RAILROAD TRACK AND KEY TRACK COMPONENTS USING A VISUAL INFORMATION SYSTEM

(71) Applicant: RETHINK TECHNOLOGIES, LLC, West Grove, PA (US)

(72) Inventors: Willem Ebersohn, West Grove, PA (US); Philip Canelli, Philadelphia, PA (US); Valerie Marcolongo, West Grove, PA (US)

(21) Appl. No.: 16/827,035

(22) Filed: Mar. 23, 2020

Related U.S. Application Data
(60) Provisional application No. 62/822,023, filed on Mar. 21, 2019.

(51) Int. Cl. G06T 7/00; G06T 11/00; B61L 23/04

(52) U.S. Cl. CPC G06T 7/0004; G06T 11/00; G06T 2207/30136; G06T 2200/24; B61L 23/042

(57) ABSTRACT

An apparatus to inspect and analyze railroad track and key track components includes an imaging module that collects image data and displays streaming video and key track components, reports and other geographical data; a data processing module that analyzes defect data; a mapping sensor that collects data related to the rail, key track components, and user location data; an image processing module that processes the image data and displays overlaid images onto the camera's field of view; a database operatively connected to the image processing module that saves the processed image data and provides past measurement and location data to the processing module; and a software module operatively connected to the database for analyzing the processed data on at least a user device.

### REFERENCE TO RELATED APPLICATIONS

This application claims the benefit of U.S. Provisional Application No. 62/822,023, filed Mar. 21, 2019, which is hereby specifically incorporated by reference herein in its entirety.

### TECHNICAL FIELD

The present disclosure is directed to monitoring safety measures in the railroad industry. More particularly, though not exclusively, the present disclosure relates to a method and apparatus for providing data and inspecting railroad tracks, and more particularly, to a rail inspection apparatus and system comprising an imaging module, processor, and a GPS module to generate a streaming image recording of visual track inspections and a computer system and method to remotely display known measured defects and location data.

### BACKGROUND

In the railroad industry, some regulations may require routine visual inspection of railroad tracks, often many miles long, for conditions such as damage, flooding, soil erosion, and the like. Inspectors, whether walking along the railroad tracks or riding in a train, typically simply rely on their own memory and instincts when inspecting the tracks.

### SUMMARY

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and extensive detailed description.

One aspect of the present disclosure is directed to help an inspector to inspect and analyze railroad track and key track components. The apparatus includes the use of an imaging module, a satellite based GPS module or a distance device for determining the user's location, a data processing module capable of analyzing data to display historical defect data overlaid onto the inspector's field of view; a mapping sensor that collects data related to the rail, key track components, and boundaries in the area, an image acquisition for receiving image data related to the rail and key track components a length of railroad track; image processing suitable for processing the image data, a database operatively connected to the processing module and suitable for saving the processed image data and providing past measurement and location data to the image output, a software module operatively connected to the database for analyzing the processed data on at least a user device; wherein the software module analyzes various aspects of the railroad track and provides instructional feedback to the user regarding changes to usage conditions and safety of the railway track. The software module includes one or more algorithms for data analysis and for determining instructional and safety feedback to the user.

In one aspect of the present disclosure, a system and method are disclosed for instructing and guiding the inspector to the location of historical defects.

In another aspect of the present disclosure, a system and method are disclosed to analyze rail conditions and to advise the inspector of the appropriate remedial action.

In one aspect of the present disclosure, the processing module is capable of outputting an augmented reality (AR) display of, among other things, rail, rail hazards, rail defect conditions, key track components, reports, and other geographical data.

In addition, another aspect of the disclosure is the processing module can analyze data to display overlaid AR images onto the field of the user.

In another aspect of the present disclosure, a system and method are disclosed for confirming that the field inspector is at the proper test location.

In addition, another aspect of the disclosure to provide for continuous monitoring of an asset condition over time, so that changes in the condition over time could be monitored and projected.

Another aspect of the disclosure is directed to a method of displaying an AR image over an actual length of rail in the user's field of view based on the location data from the user and the known location data for each asset to be inspected.

Another aspect of the disclosure is directed to a method of processing a large volume of data in a relatively short amount of time with limited interaction required by a software user.

Another aspect of the disclosure is directed to a method of confirming a track is subject to testing. The method includes the steps of capturing images of the rail, converting each image into a set of coordinates or other location data, and comparing such data to known location data.

Other features and advantages of the present disclosure will be apparent from the following more detailed description of the preferred embodiment, taken in conjunction with the accompanying drawings which illustrate, by way of example, the principles of the disclosure.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures may be designated by matching reference characters for the sake of consistency and clarity.

FIG. 1 is an overhead view of a turnout in a typical rail application.

FIG. 2A is front perspective view of a representative wearable display device.

FIG. 2B is top plan view of a representative wearable display device.

FIG. 3 is a front perspective view of a hi-rail truck on a track during inspection of the track, the hi-rail truck comprising a visual information system.

FIG. 4 is a table entitled Table 1 comprising a representative look up table of known turnout locations.

FIG. 5 is a table entitled Table 2 comprising a representative table of known asset measurement tolerances.

### DETAILED DESCRIPTION

The present disclosure can be understood more readily by reference to the following detailed description, examples, drawings, and claims, and the previous and following description. However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching of the present devices, systems, and/or methods in its best, currently known aspect. To this end, those skilled in the relevant art will recognize and appreciate that many changes can be made to the various aspects of the present devices, systems, and/or methods described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “an element” can include two or more such elements unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific aspect or combination of aspects of the disclosed methods.

A system and method are disclosed for providing data monitoring safety measures in the railroad industry and to assist in the inspection and analysis of railroad track and key track components using a visual information system 80, which in some aspects can be or can be called a “360VIS” system. In one embodiment, the system for the automated inspection and analysis of a railroad track and key track components includes: a desktop computer with monitor, a laptop computer, tablet computer, or a user wearable device (e.g. Microsoft HoloLens) each capable of displaying streaming video concurrently with known measured defects and location data related to the rail, key track components, and area boundaries (collectively, a computer). The rail and key track components aspects that can be analyzed by the disclosed system include but are not limited to transverse sections of railway switch elements (e.g. switch points 114, switch mechanism, etc.), stock rails 112, frog 104 and closure rails 110, wing rails, and half of a pair of switches, etc.

The apparatus includes: (i) at least one imaging and an image output to display streaming video and key track components, reports and other geographical data (imaging module), (ii) a processing module capable of analyzing data to display overlaid images onto a camera's field of view; (iii) a mapping sensor that collects data related to the rail, key track components, and boundaries in the area, a GPS module or a distance device for determining user location data; (iv) image processing suitable for processing the image data; (v) a database operatively connected to the processing module and suitable for saving the processed image data and providing past measurement and location data to the image output; and (vi) a software module operatively connected to the database for analyzing the processed data on at least a user device; wherein the software module analyzes various aspects of the railroad track and provides instructional feedback to the user regarding changes to usage conditions and safety of the railway track. The software module includes one or more algorithms for data analysis and for determining instructional and safety feedback to the user.

The disclosed method is used to validate inspections, to analyze data, to provide instruction feedback, to identify certain rail conditions which can lead to derailments, and for enhancing the rail inspection approach currently used. In addition, the disclosed apparatus and system provides for, among other things, expedited local and remote access to track data including geographic and historical hazard data as an integrated part of rail monitoring and inspection programs.

The use of this method as an integrated part of the rail profile monitoring program will improve safety and the data integrity of field measurements and will also allow more frequent, comprehensive, and convenient analysis of railway conditions.

Track Turnout

A modern-day high speed or heavy haul railroad switch or “turnout” is a marvel of modern engineering. A turnout is a track device for smoothly diverting a fast-moving train from a main route to a diverging route from the running track to other tracks.

In general, a turnout is what makes high speed train service efficient and an attractive mode of transportation possible.

Turnouts, crossings, and other special track work are design “discontinuities” in the railroad track structure necessitated by the physical requirements for moving a rail vehicle from one track to another or for crossing tracks. They generally consist of more than two rails, usually with complex and expensive components such as switch points, frogs, and guard rails.

Because these discontinuities generally contain changes in track geometry (often abrupt or nonuniform in nature), high levels of force are induced onto the track structure as a train negotiates the deviating transition curves at speeds of up to 80 mph.

One problem with rail transportation is during normal operation these repeated high forces result in rapid degradation of the tracks, turnout and its key components and in the worst case, cause derailments. In addition, thermal expansion or other residual stress conditions will also contribute toward track degradation.

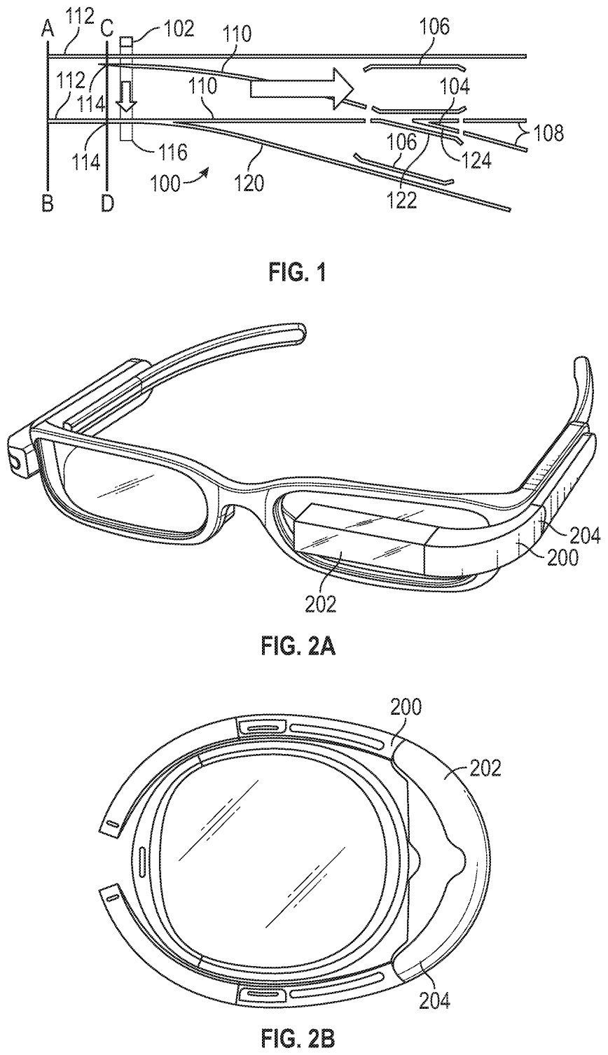

FIG. 1 illustrates a typical, standard turnout 100. As can be seen, there is a complex arrangement of rails and special track components, including the switch 102, frog 104, guardrails 106, and other special track work components. The two principal parts of a turnout are the switch 102 and the frog 104, with a connecting piece of track 120 usually referred to as the lead. The rails connecting the switch with the frog 104 in both the main-line and turnout sides are called closure rails 110.

The switch 102, which is the part of the turnout 100 that shifts the vehicle from one track to the other, is the first part of the turnout 100 encountered by the vehicle in a facing move. The switch 102 consists of the switch rails or points 114, the switch rods 116, and the switch mechanism 102 itself.

The frog 104 is the union of four rails that cross each other in such a manner that a flanged wheel rolling along either rail will have an unobstructed flangeway while passing the other rail. FIG. 1 illustrates the wing rails 122, the flangeway 124, and the frog point rails 108.

The principal function of the turnout 100 is to cross the adjacent rails of the two tracks at the frog 104. A vehicle may then be switched from one track to the other by moving the free ends of the rails.

As shown in the FIG. 1, the physical characteristics of the track change (often abruptly) at a turnout 100. These characteristics, which include lateral geometry and both vertical and lateral stiffness, directly affect the quality of the “ride” through the turnout, and the associated dynamic interaction between the vehicle and the track. This later dynamic behavior is exemplified by particularly high lateral-force levels at the switch point 114 and at the frog 104. In a similar manner, high vertical forces are likewise recorded at these two locations, with the largest vertical impact usually occurring at the frog 104.

Because the turnout 100 “steers” the rail vehicle as it negotiates its key components, the relationship between the wheel and the rail is particularly important. Any degradation in this relationship, in any direction (vertical, lateral, or longitudinal), increases dynamic loading, the corresponding rate of degradation (maintenance), and the associated risk of failure (derailment). It is thus of key importance that this wheel-rail interface be optimally maintained within the turnout 100 or other special track work components 104, 108, 110. This is particularly true when instances of complex interlocking, such as multiple turnouts, are used.

Because of the complex geometry of the turnout and variations in the turnout structure, with its resulting changes in vertical and lateral stiffness, rail vehicles impose a level of loading on the turnout that is generally much more severe than that experienced by normal track. This, in turn, leads to a more rapid rate of degradation within the turnout. This degradation takes several forms which include: degradation of the running surface of the turnout and its major components; degradation of the geometry of the turnout; and degradation of the key turnout components. Usually these forms of degradation will occur simultaneously, as the rate of degradation is interrelated with the development of surface defects.

The effect of the deterioration is generally to increase the level of wheel-rail forces within the turnout, and to further increase the rate of degradation. As a result, component life for special track work components is significantly shorter (in some cases one tenth that of normal track component life), and corresponding special track work maintenance costs are significantly higher.

Therefore, inspecting and maintaining proper conditions of rail components is of paramount importance in the railroad transportation industry.

Track Inspections and Equipment

With about 177,200 miles of track in service as part of the interstate railroad system, maintaining proper conditions of railroad track, key track components, and area boundaries for certain hazards are of paramount importance in the railroad transportation industry. Jurisdiction over track quality falls to the Federal Railroad Administration (FRA), which first began overseeing track standards after passage of the Railroad Safety Act of 1970. Track inspection is performed by the FRA as well as the railroad owners themselves. The overwhelming majority of railroad inspectors—literally thousands of them—work for railroad engineering departments.

The FRA requires periodic maintenance inspections of railways to ensure safety of track structures. The FRA prescribes minimum safety requirements for railroad track inspections in 49 CFR Part 213. As mandated by 49 CFR 213.233(b), railway track inspections rely, in large part, on visual inspections of tracks, which require that visual inspections shall be made (i) on foot, or (ii) by riding over the track in a vehicle at a speed that allows one or more inspectors viewing the track through an automobile window to visually inspect the track structure and surrounding areas for compliance with the FRA's safety parameters as well as any standards established by the rail owner.

Frequency of track inspection depends on another FRA rule that categorizes track as either “main track” or “other than main track.” Main track must be inspected twice weekly, with a minimum of one calendar day interval between each inspection. This standard applies to main track in all classes, 1 through 6. Other than main track must be inspected monthly, with at least 20 calendar days between each inspection, again regardless of class.

In two-track territories, the inspector generally walks 10 route miles (or 20 track miles) per day, viewing two tracks simultaneously for defects. Upon detecting a potential defect, the inspector must move outside the safety envelope to note the type of defect, its approximate location, and to prepare a written assessment. Depending on the nature of the defect, the inspector can either take action to correct the defect or order the appropriate remedial action such as taking the rail out of service or derating the maximum speed of any train that passes over the affected portion of track until the defect is resolved.

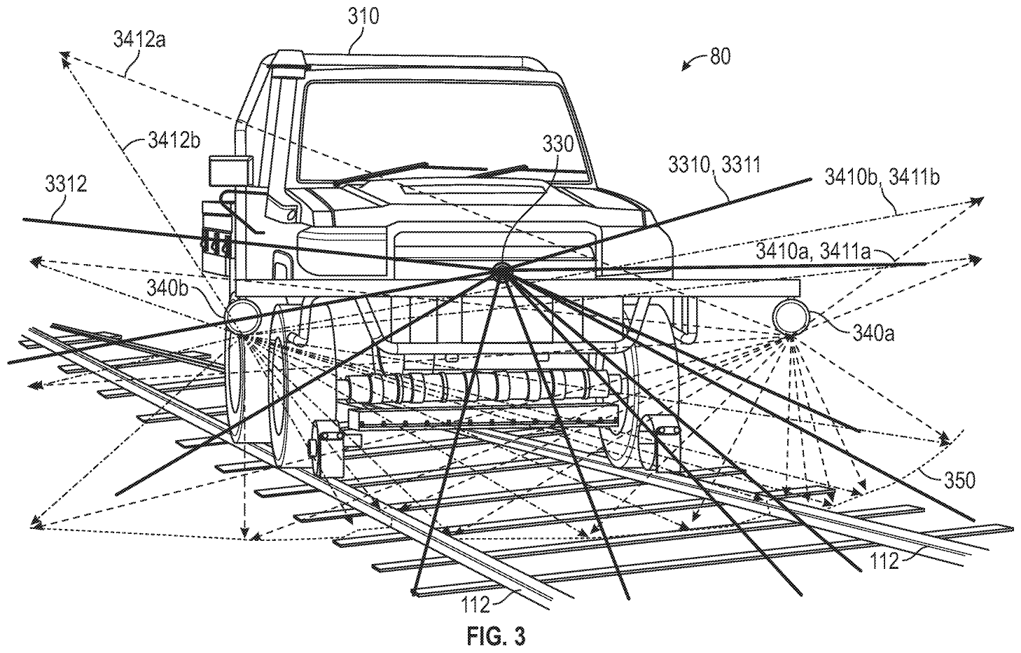

For visual inspections made while riding over the track, a vehicle 310 (shown in FIG. 3) modified to ride on rails such as adapted highway trucks, in some aspects more commonly called a “hi-rail truck”, is used to travel on top of the rails by use of at least one set of front railroad wheels. The FRA provides that one inspector in a vehicle may inspect up to two tracks at one time and, similar to walking inspections, upon detection of a potential defect, the inspector notes the type of defect, its approximate location, and either acts to correct a potential defect or orders an appropriate remedial action.

In general, most track inspections are visual inspections in which the quality, data integrity, and overall safety of visual inspections are generally poor. Visual inspections are particularly fraught with a plethora of potential human errors such as incorrect data entry, transcription errors, incorrect testing locations, incorrect assessments, incorrect field calculations, poor inspector judgment, intentional neglect, etc. In addition, the efficiency and validity of visual inspections are severely impacted by inclement weather and are, in the best environments, a slow and tedious process, requiring many hours to inspect a limited range of track not to mention the inspector's exposure to rail operations safety hazards either when walking or when exiting the hi-rail truck to conduct a more thorough review of a potential defect.

U.S. Pat. No. 6,356,299, hereinafter referred to herein as Trosino, et al., discloses an automated track inspection vehicle for inspecting a railroad track for various anomalies. The automated track inspection vehicle disclosed includes a self-propelled car equipped with multiple cameras for creating multiple images of the track. This reference discloses that a driver and an inspector visually inspect the track and right-of-way through a window in the vehicle.

The Trosino et al system discloses the use of six programmable pushbuttons to identify specific types of anomalies. For instance, pushbuttons may indicate (i) weeds or other growth in or near the tracks; (ii) a missing clip or a broken insulator; (iii) a defective tie; (iv) blockage in a drainage ditch; (v) a ballast problem; and (vi) any other anomalies not otherwise classified.

The reference further discloses that the pushbutton has dual functionality such that once the pushbutton signal is triggered, short segments of the track image data including the potentially anomaly is recorded for later review by an analyst. According to one aspect of the disclosure, the step of creating images of the track includes creating separate images of the track through multiple cameras at various locations on the car. The reference notes that the analyst sometime later reviews the stored image data to confirm or deny the presence of an anomaly. After confirming the anomaly, the method includes generating a report of the anomaly. Preferably, the step of generating a report includes recommendations for remedial action to be taken for the anomaly.

The significant limitation of the inspection vehicle disclosed in Trosino et al. and the method taught therein requires the inspector to continually perform visual inspection of the railroad track while concurrently selecting specific pushbuttons to classify specific types of anomalies. Such inspection technique, in and of itself, is hazardous as it requires the inspector to take his attention completely away from the tracks while the traveling on the railroad track conducting an inspection. The reference further discloses that the inspection vehicle permits inspection of a railroad track at speeds of 30-50 miles per hour or faster. Traveling at just 30 miles per hour, an inspector is viewing 44 feet per second. If, during an ongoing inspection, the inspector diverts her attention for just 10 seconds to attend to pushbuttons, she will miss approximately 440 feet of track. At 50 miles per hour, she will miss 733 feet. Thus, the method disclosed in Trosino et al. is, at best, not much better in quality than the conventional method for hi-rail visual inspection noted above.

In addition, in areas where there is a high-speed rail traffic, it is not feasible to tie up the track with slow moving high rail trucks during the day, and nighttime testing with the vehicle system disclosed in Trosino et al. is not possible due to lighting constraints as well as shadows caused by multiple lights. Hence, walking inspections are still required in such areas.

The limitations of the Trosino et al. method is further exacerbated by the fact that defects or damage to the rail portions of the turnouts, i.e. switch points 114, stock rails, frogs and closure rails 110, are especially difficult to see during a hi-rail inspection and are likely to missed. The method taught in Trosino et al. also requires three trained individuals working at the same time. Whereas, conventional hi-rail inspections only require two trained individuals. In addition, the disclosed inspection vehicle requires the inspector to press an appropriate pushbutton, indicating the type of anomaly identified, in order for the vehicle to capture and store the images of the railroad track for review by the analyst. Again, the result of missing numerous defects is significant since a recording is not captured for post inspection review by the analyst.

In addition, the cameras used in the inspection vehicle disclosed in Trosino et al. are fixed in a stationary position, each with a single, narrow field of view, and subject any environmental conditions may exist.

If the inspector is not viewing the correct camera display, or simply does not see an anomaly, and/or fails to push the appropriate pushbutton, no images are captured or subsequently reviewed by the analyst. The reference further discloses that the inspection vehicle permits inspection of a railroad track at speeds of 30-50 miles per hour or faster. Among other things, at such speeds, the inspector is traveling 44-70 feet per second so the timing of the pushbutton becomes extremely difficult. As discussed above, if the potential anomaly is not captured or simply not captured in a camera's field of view, it is likely to go unreported. Therefore, whereas the railcar vehicle of Trosino et al. may be suitable for inspecting a railroad track for large anomalies which are easily visible to the inspector, such as the presence of a fallen tree, water build-up, etc., the described inspection method does not facilitate the inspection of the more typical defects that are most commonly associated with smaller rail components. Thus, the Trosino et al. system thereby allows for an unacceptable high percentage of missed anomalies which makes its practice unreliable in today's rail transportation industry.

Furthermore, the Trosino et al. system does not have the ability to confirm that an inspector is at the proper location and conducting an inspection. An inspection validity system such as that disclosed herein greatly reduces the opportunity for inspection errors as well as intentional inspector negligence as caused by falsified inspection reports.

The railroads and the FRA also use special high-tech equipment and inspection vehicles to test aspects of track condition which cannot be detected by visual inspection, notably track geometry and internal rail defects. Federal law requires annual internal rail inspection for all track in classes 3 through 6 subject to use by passenger trains.

Many other vehicle-based rail measurement systems are known in the industry and are used to precisely monitor gauge, alignment, and profile measurements of the rail head of the running rails 112. These rail head profile measurement systems are usually mounted on inspection vehicles, such as specialized railroad track geometry inspection cars that can operate at high speed (80 plus mph) and record images every 5 to 20 feet. Most of the Class 1 systems have their own track geometry cars. Some carriers have their own rail detection vehicles. Most, however, relay on outside contractors for rail inspection. These companies use a variety of ultrasonic, induction, and other techniques to check rail integrity.

There are currently several such optical or laser-based systems that are commercially available and in active use. They generally follow the same principle, using a light source or laser to illuminate the rail head. The illuminated rail profile is then recorded by a highly focused CCD (charge-coupled device) camera or related recording device, and the image stored in a digitized format. The Optical Rail Inspection and Analysis system (“OMAN”), distributed by KLD Labs, Inc., represents one such commercially available system that are used for automated and portable measurement systems to assess rail profiles and rail wear conditions such as rail height, vertical wear, rail width, lateral wear, field/gauge metal flow-lip, rail inclination, track gauge, rail cant (rail inclination), and joint bar/fish plate presence as well as other customer defined measurements.

Another commercially available rail measuring system is the Laserail system, distributed by MERMEC, Inc., which manufactures, among other things, automated optoelectrical measuring systems that utilize laser scanners for precision measurement of track geometry in a variety of operational conditions.

While these systems all generate digitized rail head profiles for the stock running rails 112, they neither facilitate the visual inspections mandated by 49 CFR 213.233(b) nor do they help identify any defects other than precision profile defects on running rails 112 (i.e. they do not analyze or generate digitized profiles for switches 114, frogs 104 or other such components of turnouts). Moreover, none of the data generated from current geometry inspection systems are provide to an inspector for use in her visual inspection. Therefore, usefulness of such prior systems has been limited to obtaining precision measurement data on running rails 112.

FIG. 3 shows an illustration of one embodiment of the disclosed system 80 in accordance with the present disclosure. The system 80 facilitates inspection of rail components while traveling on the railroad track. As will be described in more detail below, the system 80 facilitates inspection of rail components such as joint bars, switch frogs, rail fasteners, switch points 114, and rails themselves as well as such things as loose spikes, defective ties, weeds or other growth growing near the tracks, brush or other growth blocking signals, blockage in a drainage ditch, catenary wires hanging too low, or a weakness in the ballast. As will be discussed below, the system 80 utilizes digital video, computer imaging, computer processing, and illumination technologies to allow accurate, and efficient inspection of rail components, with reduced time and effort as compared to the prior art as well as conventional methods of inspection. It should be noted that whereas the present disclosure is described in detail below as inspecting the items referenced above, the present disclosure is not limited thereto, and may be utilized for inspection of any rail component that can appropriately be inspected using the system 80.

Inspection Validation.

The disclosed system and method include the steps of confirming that testing is taking place at the proper location; using overlaid AR images to detail the inspection points and historical defect data; record the defect data; check compliance; and providing instructional feedback to the user.

The inspection system includes a method of validating that testing is taking place at the proper location. In order to provide location information, a GPS module includes a GPS receiver, and a query methodology for locating the receiver. The GPS module tracks the position information from a GPS satellite system (either regularly or as needed) and can send the location information via wireless communication channel when a location query is submitted.

When an inspection is about to begin, an inspector's location can automatically be derived from the GPS module. Alternatively, the inspector can input location information into an inspection report. The input can be a barcode reference, a specific internal track location number (e.g. Turnout 283), or other location information such as latitude and longitude coordinates. Once the inspector's location is derived, a database is queried to compare the location information to a reference table that includes known GPS location information for each asset to be inspected.

Importantly, all rail profiles are tagged with absolute GPS coordinates, the location of the profile closest to a switch point 114 will then automatically be cross-referenced in a connected database that listed the names, locations, and properties of all switches on a railway's system so the appropriate standard is applied to the asset.

After comparing the input and reference data, a confirmation of the proper location is transmitted to the inspector and the result is communicated audibly and/or displayed as AR to the user's field of view. Moreover, if the user is at the correct testing location, the monitor or the user wearable device (FIG. 2a, 2b) will display an AR inspection report with instruction to proceed.

The testing location confirmation is preferably done via a GPS receiver that allows determination and monitoring of the position of where the inspection system is implemented. Although a GPS module and the display (e.g. a monitor or the user wearable device) may be integrated into a single component, location functionality may also be accomplished by two separate connectable components capable of communicating over a wireless network, whereby the GPS module and the user wearable device may transfer location information between devices using Bluetooth technology. Provided one of these devices knows its position (because it is in fixed position or because it has a GPS receiver or GPS sensor, or other ways of determining its own position), then this positioning information can be transferred to other devices in the radio frequency proximity. For example, the Garnet DL manufactured by Geismer, is a precision digital track gauge for track and switches geometry measurement of the kind utilized for performing tests and measurements on a track and/or turnout. The Garnet DL is integrated with both a GPS receiver and Bluetooth connectivity. Therefore, with the Bluetooth connection, the Garnet DL can communicate position data (latitude, longitude, and altitude) as well as measurement data to the user wearable device (FIG. 2a, 2b).

The GPS tracking may be performed by well-known tracking technologies such as that disclosed in U.S. Pat. Nos. 8,362,949; 5,379,224; and 8,447,328 which are incorporated herein by reference.

In a further alternative embodiment, location information may be calculated according to U.S. Pat. No. 8,362,949 which discloses a computer-implemented method for obtaining the user's location by combining data from a GPS location receiver with information from Microelectromechanical system devices such as an acceleration detector and a gyroscope using statistical analysis techniques such as a Kalman filter to estimate the location of the device with greater accuracy while using numerical methods such as the Newton-Raphson Method to minimize power consumption.

Walking Inspection

One embodiment of the inspection system disclosed herein includes a computer such as a user wearable device (shown in FIGS. 2A and 2B) that provides, among other things referenced below, an augmented reality display and a processor 204. Although other AR display systems are possible, one embodiment is shown in FIG. 2A, which is a wearable device made by Alphabet, Inc. and another embodiment is shown in FIG. 2B, which is a HoloLens made by Microsoft Inc. Each are incorporated herein by reference.

The Microsoft HoloLens is an untethered holographic computer with advanced optics and sensors to display 3D holograms in the field of view of the user. Unlike virtual reality headsets, which produce immersive visual images via OLED displays that are situated right in front of your eyes, HoloLens is a passthrough device. That is, you see the real world through the device's clear lenses, and AR images are projected out in front of you, up to several meters away.

The HoloLens also comes with a Qualcomm Snapdragon 850 system-on-a-chip. HoloLens also features a 2nd Generation Custom-built Holographic Processing Unit 204, 2 k 3:2 screens, a new Azure Kinect sensor, various sensors (Accelerometer, Gyroscope, Magnetometer) and an imaging module that can capture 8 MP stills and 1080p30 video 202. The Microsoft HoloLens also has Wi-Fi 802.11ac 2×2 accessibility as well as USB Type C and Bluetooth 5.0 connectivity along with 64 GB Flash memory (not shown) and 2 GB RAM (not shown), for processing and storing data and instructions associated with the control and function of the interface device and the software analyzer, and to further store the images of the rail components.

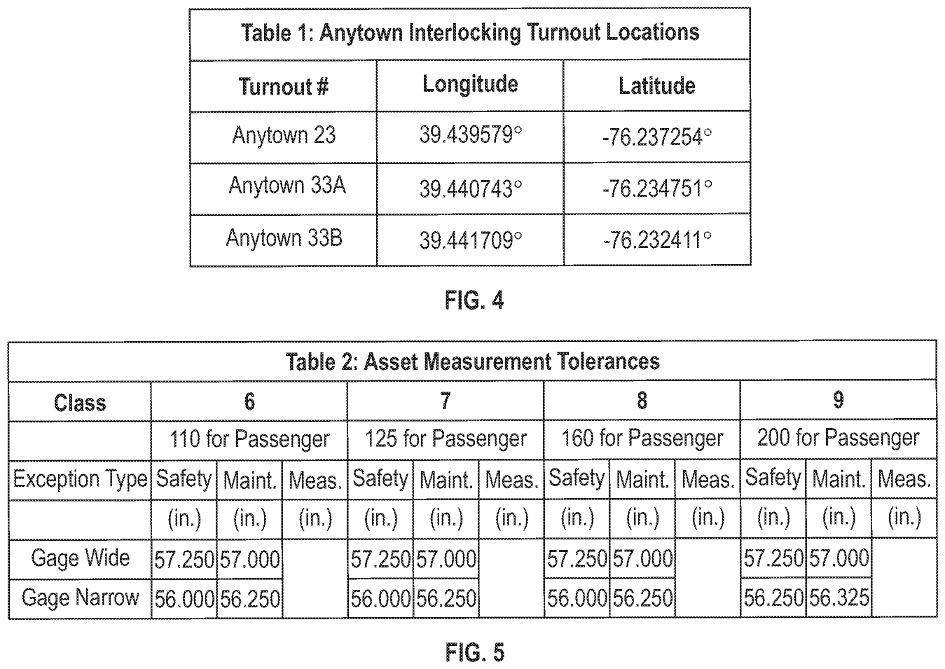

Based on the absolute position of the rail profile, the user can access a database with asset survey data and additional latitude and longitude coordinates that detail key track features and the rail's profile (see Table 1 shown in FIG. 4) as well as components within the section of rail (e.g. turnout) that are subject to inspection. Based on the data related to the rail, key track components, and area boundaries, the user wearable device can display an augmented reality (AR) view of additional measurement. Alternatively, certain rail and key components are associated with a digital file specifying their exact location data. Therefore, images of those rail and key components can be converted into a set of Cartesian coordinates that traces the transverse cross-sections of the respective rail. The rail of the component may be conventional “running” rail, such as closure rail 110, or may be a part of a special component, such as a switch, frog, etc. This allows each respective image and its respective Cartesian coordinates to be identified to a specific and exact location of the track and featured in the AR display.

The display system may include an AR display for creating an AR image overlaid on a known length of rail based on the location data from the user and the known location data for each asset to be inspected, and the sensor system on the user wearable device. The sensor system may include one or more sensors such as optical sensors (e.g. environment understanding sensors, depth sensor, light sensor, etc.) for detecting, tracking, and/or monitoring user interaction with the AR image projection. Sensor systems noted for the HoloLens are fully disclosed in U.S. Pat. No. 9,626,936 and incorporated herein by reference.

The software analyzer applies data analysis logic to confirm that the shape of rail profile is consistent with the known rail profile shape, for example, as a switch in the closed position. If the analysis confirms that the switch is in the closed position, data quality filters are applied to the known coordinates to display an AR overlay of the inspection points at or near the original rail profile.

As previously described, once the location information is confirmed, the inspector commences the inspection. If a walking inspection, a computer may be used to assist the inspector. In walking inspections an asset is manually measured using a rail measurement device (e.g. Garnet DL manufactured by Geismer) to determine actual track gauge measurements and to compare such measurements to established tolerance limits (see Table 2 shown in FIG. 5) to determine if safety or maintenance issues are present.

As noted above, certain measurement devices such as the Garnet DL manufactured by Geismer have digital measuring and Bluetooth capabilities. This provides for the wireless transmission of digital track gauge measurements directly to the computer (i.e. user wearable device) and to automatically input such data on the inspector's inspection form without any human intervention. To the extent that a measurement device does not have wireless capabilities, such measurement information can be manually input to the inspection form by user interaction. User interaction may refer to user keystrokes as well as an audible input or a gaze, gesture or other movement performed by a user within a vicinity of the AR image projection. A gesture may correspond to stationary or non-stationary, single or multiple, touches or near touches on the AR image projection. Because the AR image projection is an optical illusion, a “touch” may refer to the placement of a user's finger or other object within a certain distance of the AR image projection. A gesture may be performed by moving one or more fingers or other objects in a particular manner within the vicinity of the AR image projection. A gesture may be characterized by, but is not limited to, a pinching, sliding, swiping, rotating, flexing, dragging, or tapping motion between or with one or more fingers. A single gesture may be performed with one or more hands, one or more objects, by one or more users, or any combination thereof.

Once the measurement data is input to the inspection form, the measurement data is then compared to a table of tolerance limits (see Table 2 shown in FIG. 5) and a determination of serviceability is output for each test result indicating problem areas. In one embodiment, a visual AR image will be displayed on the AR form and/or specific track locations showing passed areas in green and areas with safety issues in red and maintenance issues in yellow.

Hi-Rail Inspection

As depicted in FIG. 3, another aspect of the operation of the system 80 is for the inspector to utilize the system in the cab of the vehicle 310, which can be a hi-rail truck or railcar. During a conventional hi-rail visual inspection, the inspector sits in the passenger seat of the vehicle 310 and views the track through the front and side windows of the vehicle 310 to detect defects on the tracks and surrounding area.

The system 80 provides the inspector in the passenger seat of the vehicle 310 a real-time video display on at least one computer display (including, but not limited to an AR headsets or virtual reality device) with left and right views of the track in front of the vehicle 310. The total field of view is preferably no less than 170° in the vertical plane and 90° in the horizontal plane. The configuration of two HD cameras 340a,b and one wide angle camera 330 (preferably a high-resolution spherical camera with at least a 170° field of view in the vertical plane) will enable an inspector to have full field of view of all four vertical surfaces of the two rails as well as full perspectives of topography, vegetation, and structures along the track as depicted by the arrows 3310,3410a,3410b in FIG. 3, each represented by a different line type as shown. More specifically, the arrows 3310 emanate from the camera 330 and can represent a field of view of the camera 330 (i.e., exemplary camera sight lines representing what the camera 330 can capture in an image). An arrow 3311 can represent an exemplary camera sight line at a first end of the field of view of the camera 330, and an arrow 3312 can represent an exemplary camera sight line at a second end of the field of view of the camera 330. Similarly, the arrows 3410a,b emanate from the respective cameras 340a,b and can represent a field of view of the respective camera 340a,b (i.e., exemplary camera sight lines representing what the respective camera 340a,b can capture in an image). Arrows 3411a,b can represent exemplary camera sight lines at first ends of the fields of view of the cameras 340a,b, and arrow 3412a,b can represent exemplary camera sight lines at second ends of the fields of view of the respective cameras 340a,b. A line 350 can represent a portion of the topography, vegetation, and structures along the track (including the track and rails 112 themselves) being captured.

The graphical user interface of the present disclosure is overlaid with a countdown indicator (e.g. distance timer, time to defect, etc.) to an upcoming defect based on a preloaded set of defect data. In addition, an auditory tone is preferably used to audibly alert the inspector of an upcoming defect based on a preloaded set of defect data. The defect data represents known indicators of compromise to aid the Inspector in the visual identification of elements within the rail environment of known historical defects. The historical defect data may include, but is not limited to, (i) Geometry Car survey exceptions; (ii) Rail wear exceptions; (iii) autonomous ride quality measured defects; (iv) track loading vehicle defects; (vi) Ground Penetrating Radar identified problem zones—drainage, fouled ballast, etc.; and (v) exceptions from prior visual inspections.

The defect data can be provided in many common formats but the preferred embodiment utilizes comma-separated values, also known as CSV. The example data in Table 1 of FIG. 4 shows location information only. The defect data may also include date and timestamp, measured condition defect type, and measured conditioned measurement.

Whether the inspector detects an anomaly through a truck window or on the display terminal, the inspector can annotate the video image with, among other things, the type, location, potential cause of defect, and recommendations for remedial action to be taken. This data, along with the video of the anomaly, will be assigned priority for remote viewing and entered into a report generated at the end of the shift.

In addition, the disclosed system provides the capability to download high-quality streaming image recordings to solid state device or USB device for post inspection review of the streaming image on a remote laptop device or AR/VR headset (i.e. Microsoft HoloLens). It also provides the inspector with the capability to transmit still images in near real-time to a back office through Wi-Fi or cellular connectivity.

The system 80 provides the capability to manually extract sample set of timestamped defects (i.e. keyhole markup language, also known as .kml) and display those points on a satellite imagery application (i.e. Google Earth) against a survey inspection file detailing the rail's geo-referenced path.

In addition, the disclosed system provides the capability to launch and review a GPS referenced defect by clicking on an icon on the geo-referenced path display (i.e. Google Earth) representing the defect location along the inspection path. The system 80 will start the video streaming a set distance ahead of the geotagged location enabling the inspector to review the defect location and surrounding features.

Referring in more detail to FIG. 3, the vehicle 310 includes a hi-rail truck or any suitable self-propelled vehicle adapted to travel along railroad tracks. While the system 80 is capable to operate at speeds up to 120 miles per hour, the FRA mandates that the speed of the vehicle may not be more than 5 miles per hour when passing over track crossings and turnouts, otherwise, the inspection vehicle speed shall be at the sole discretion of the inspector, based on track conditions and inspection requirements. Railroad companies typically recommend that a hi-rail visible inspection is best performed at speeds no greater than 15 miles per hour and preferably in the range of 5 to 10 miles per hour. Conducting a visual inspection at any speed greater than 15 miles per hour, is extremely difficult and likely to result in numerous errors or missed defects. As previously mentioned, the system 80 has the benefit of operating at speeds up to 120 miles per hour and then reviewing the images at reduced speeds equivalent to a typical track inspection (5 to 10 miles per hour).

As disclosed, the preferred embodiment includes at least the camera 330, which is preferably a high-resolution spherical camera, mounted centrally, above the front bumper of the exterior of the vehicle 310. The height of the camera 330 is preferably four to five feet above the track with a slight downward pitch of 15° to 20°.

While the system disclosed herein operates most efficiently with only the one camera 330, another embodiment of the present disclosure includes the two additional cameras 340a,b focused on the exterior side of the proximal rail and the interior side of the adjacent rail as well as the areas adjacent to the proximal rail known as the track envelope. One possible configuration for the two right-of-way cameras 340a,b is to mount them above each end of the front bumper extending approximately 4.5 inches past the exterior of each rail and raised approximately 48 inches above the track. Once mounted, each of the cameras 340a,b should or at least can focus downward and inward to the exterior side of the rail approximately 60 inches in front of the respective camera 340a,b. Another possible configuration may require additional cameras spaced at various crosswise locations to obtain full, continuous wide angle field of view of the front perspective, a plan view of each track, all four vertical surfaces of the two rails 112 (i.e. the field side view of the track components and side of the rail located outside of the two rails and the gage side view of the track components and side of the rail located between the two rails), the crossties, ballast, catenary as well as a view of the surrounding topography, vegetation, and structures along the sides of the tracks without any functional blind spots. Of course, these components may be mounted to any appropriate structure in any appropriate manner or angle.

If necessary, the vehicle 310 may also utilize right-of-way lights adjacent to the camera 330, and diffused downward and shoulder road-bed lights to provide illumination of the track while eliminating shadow effects and to avoid distracting other train operators.

A GPS sensor for location data, and, if necessary, one or more light sources. These components are located on the front the vehicle 310 as depicted in FIG. 3. It should be noted that FIG. 3 merely shows an illustration of the system 80. Thus, the relative positioning of the various components of the system 80 is shown merely to facilitate understanding and need not represent the actual relative positioning of these components.

In addition to the components that are located on the front of the vehicle 310, the system 80 also includes a computer with a cab-mounted terminal to display the streaming video, still images, the defect data, and the counter/timer and speaker for audible warning tone. The graphical user interface and counter/timer device may be discrete devices but are preferably housed in the computer and connected to the bus of the computer. In addition, the interface device and the counter/timer device may be implemented as boards but may also implemented differently in other embodiments. Furthermore, the interface device and the counter/timer device may be implemented as a single integrated board. However, these devices are discussed as being implemented separately herein to more clearly describe their respective functions.

The computer of the illustrated embodiment has a processor and memory, for processing and storing data and instructions associated with the control and function of the display terminal device and the counter/timer device, and to further store the images of the rail components. In addition, the computer is also preferably provided with digital image processing software and/or hardware that are adapted to process the images of the rail components that have been captured. The digital image processing software/hardware may be any appropriate software/hardware that allows performance of image processing as described in further detail below. If implemented as software, the software can be stored in the memory as well.

Furthermore, the system 80 of the illustrated embodiment preferably utilizes the camera 330 and can include a GPS receiver that allows determination and monitoring of the position of the vehicle 310 on which the system 80 is implemented. These components of the system 80 are provided on the vehicle 310, and thus, can be utilized to inspect the rail components while traveling on the railroad track. The details of these various components of the system 80 and their operation are further discussed below.

The system 80 creates, captures, stores and manipulates the images of the track. The camera 330 and any other cameras and camera components constitute the imaging module. The imaging module must provide enough resolution and shutter speed to allow stop action viewing of images on a frame by frame basis without blurring as the vehicle travels at the desired operating speed. The imaging module may be a board imager or a housed camera. In either case, for operating speeds in the range of 5 to 25 miles per hour, it is recommended that the imaging sensor comprise at least a 1/1.8-inch complementary metal-oxide-semiconductor sensor (CMOS) or charge-coupled device sensor (CCD) with resolution of at least 2,048×1,536 and up to 120 frames per second. For operating speeds in the range of 25 to 120 miles per hour it is advisable to utilize a camera with less resolution but capable of capturing moving images with exposures of less than 1/1,000 second or frame rates in excess of 250 frames per second. For example, the DFM 37UX287-ML USB 3.1 color board camera manufactured by the Imaging Source, LLC produces 720×540 resolution with up to 539 frames per second. At 500 frames per second, the system 80 captures nearly 17 images for every one that would be captured by standard (30 fps) video. Comparatively, the DFM 37UX178-ML USB 3.1 color board camera also manufactured by The Imaging Source, LLC produces 3,072×2,048 resolution but only up to 60 frames per second. The specification for The Imaging Source, LLC cameras referenced herein are available from the manufacturer's website and are incorporated herein by reference. Utilizing any of the above referenced cameras such as the camera 330 or the cameras 340a,b, the system 80 can capture a motion sequence at a high frame per second rate and later view it at 30 frames per second, to smooth, continuous motion. In addition, the system 80 initiate the imaging process upon initial movement of the train or high rail and terminate the program at a full stop. Further, the system 80 can increase or decrease the frames per second to correspond to the increase or decrease of the speed of the train or high rail. In general, the Amtrak Acela trains have a 71:23 gear ratio and are designed with a top speed of 165 miles per hour and reach a maximum operating speed of 150 mph in regular service. Ideally, an Acela train operating at 150 miles per hour, may require the system 80 to capture at least 300 frames per second. Alternatively, a train or high rail operating at 15 miles per hours, may require the system 80 to capture only 30 frames per second. Viewing the output of the system 80 at 30 frames per second provides ideal image detail for the processor to analyze the image data.

For operating speeds in excess of 15 miles per hour, it is advisable to employ an image sensor with a global shutter. Global shutters allow all the image pixels to accumulate a charge with the exposure starting and ending at the same time. At the end of the exposure time the charge is read out simultaneously. In turn, the image has no motion blur on moving objects. At low speeds (less than 15 miles per hour), a rolling shutter is acceptable. Rolling shutters expose the pixels by row with each row having a different start and end time frame. The top row of the pixel array is the first to expose, reading out the pixel data followed by the 2nd, 3rd & 4th row and so on. Each of the rows start and end point have a delay as the sensor is fully read out.

In another embodiment, a suitable spherical camera for use in the system 80 are the Ladybug systems (such as, the Ladybug 3, Ladybug 5, and Ladybug 5+) available from FLIR Integrated Imaging Solutions, Inc. (FLIR). Ladybug spherical imaging systems uses six high quality Sony® CCD image sensors to deliver images gathered from six vantage points with 30 megapixels of total resolution covering 90% of a full sphere. Five CCDs are positioned in a horizontal ring and one is positioned vertically pointing upwards. The Ladybug systems do all the image acquisition, processing, stitching and correction necessary to integrate multiple camera images into full-resolution digital spherical and panoramic streaming video in real-time. The specification for this camera is available from the manufacturer's website for FLIR and is incorporated herein by reference. Of course, the noted Ladybug systems are described merely as one example of a suitable spherical camera that may be used in the system 80, and other cameras may be used in practicing the present disclosure in other implementations.

The lighting system provides the necessary illumination to the imaging module to allow it to function properly in various lighting environments. In one embodiment, up to four 36-watt outdoor light emitting diode (LED) spotlights may be preferably mounted adjacent to cameras such as the cameras 330,340a,b. The spotlights can be focused on the approximate center of the camera's preferred field of view. The unit, GL-30674 LED Golight Stryker (2,520 lumens) manufactured by Larson Electronics, LLC includes a weather resistant housing constructed of high quality ASA Luran thermoplastic that is heat resistant, impact resistant, UV resistant and able to withstand rugged use and abusive conditions. LED illumination lamps are preferred over halogen because they are generally more powerful while using less power on a 12- or 24-volt system, making it well suited to vehicles where power supply is limited. In addition, unlike gas burning and arc type lamps that have glass bulbs, LEDs have no filaments or fragile housings to break during operation and/or transportation. Instead of heating a small filament or using a combination of gases to produce light, LEDs use semi-conductive materials that illuminate when electric current is applied, providing instant illumination with no warmup or cool down time before re-striking.

Because there is no warmup period, this light can be cycled on and off with no reduction in lamp life. LED lights also run at significantly cooler temperatures than traditional metal halide and high-pressure sodium lights and contain no harmful gases, vapors, or mercury, making them both safer and more energy efficient. Moreover, the operator risks associated with traditional lighting methods, such as accidental burns and exposure to hazardous substances contained in the glass bulbs, are eliminated. In addition, LEDs are also safer for the environment as they are 100% recyclable, which eliminates the need for costly special disposal services required with traditional gas burning and arc type lamps. The specification for the GL-30674 LED Golight Stryker is available from the manufacturer's website for Larson Electronics, LLC and is incorporated herein by reference. Of course, other appropriate light sources and mountings may be used in other implementations of the video inspection system of the present disclosure.

Another aspect of the current disclosure is to utilize multispectral imaging modules for visible-to-near-infrared capability for deployment in various environments such as low light or completely unilluminated tunnels, assisted night vision, UV/IR authentication, biological detection, urban growth analysis, disaster assessment, pest identification, measure irrigation and drainage systems, survey fencing, platforms and trackside buildings, etc. A multispectral imaging module features a high speed, continuously rotating filter wheel containing custom, interchangeable optical filters for the desired usage environment.

Near Infrared (NIR) is a subset of the infrared band of the electromagnetic spectrum, covering the wavelengths ranging from 0.7 to 1.4 microns. This wavelength is just outside the range of what humans can see and can sometimes offers clearer details than what is achievable with visible light imaging. NIR is very close to human vision but removes the color wavelengths, which results in most objects looking very similar to an image that has been converted to black and white. One exception is trees and plants, which are highly reflective in the NIR wavelength and thus appear much brighter than they do in color. That difference in reflectivity of certain objects, in combination with reduced atmospheric haze and distortion in the NIR wavelength, means that detail and visibility are likely to be improved from prior art inspection systems. The longer wavelengths of the NIR spectrum can penetrate haze, light fog, smoke and other atmospheric conditions better than visible light. For distance imaging of growth growing near the tracks, brush or other growth blocking signals, blockage in a drainage ditch, catenary wires, etc. the images are often sharper, less distorted image with better contrast than what can be seen with visible light in prior art cameras. Unlike thermal camera systems which displays objects quite differently from visual perception, NIR is a reflected energy that behaves similar to visible light, which means that it can see sharp detail like raised spikes, cracked ties, printed information on tracks and rail side signs. As noted above, the system 80 utilizes glass HD imaging lenses for visible imaging but with a motorized IR filter. Therefore, an additional lens and sensor are not needed. At the inspector's discretion, by adjusting camera settings in the software of the system 80, a motorized IR filter is applied and the sensor switches to a special NIR mode, allowing the operator to quickly switch back-and-forth between the two imaging methods.

NIR is a reflected energy like visible light, which means that an NIR light source is required to create an image. During the day there is enough IR light from the sun, but at night or while traveling through a tunnel, an IR light source is needed to illuminate an inspection area. IR light sources have the advantage of being invisible to the human eye so they can be focused on all desired areas without the potential to distracting oncoming train engineers or surrounding neighborhoods.

IR LED arrays are commonly used to illuminate areas that are too dark for cameras to obtain a clear picture. Most LED arrays are effective for a range of up to 300 meters which exceeds almost all visual inspection use cases and IR LED arrays are preferred over the use of laser illumination technology that can cause permanent eye damage if directly viewed at a range closer than the specified eye-safe distance and/or while not wearing protective eyewear.

The system 80 stores data both locally on a connected hard drive and off-site in a cloud storage system. Provided a network is available, data read and write requests are continuously received by a cloud data storage system. If a network is not available, the data and write requests are paused or queued until such time that a network is available for transmission. In a networked deployment, the data transmission may operate in the capacity of a server machine or a client machine in a client-server network environment, or as a peer machine in a peer-to-peer (or distributed) network environment. The transmission may be facilitated by a personal computer, a tablet PC, a set-top box, a Personal Digital Assistant, a cellular telephone, a web appliance, a network server, a network router, a network switch, a network bridge, or any machine capable of executing a set of computer instructions (sequential or otherwise) that specify actions to be taken by that machine. The term “machine” shall be understood to include any collection of machines that individually or jointly execute a set (or multiple sets) of instructions to perform any one or more of the methodologies discussed herein. The cloud storage system has at least three data storage layers. A first high-speed layer, a second efficient storage layer, and a third off-site storage layer. The first high-speed layer stores data in raw data blocks. The second efficient storage layer divides data blocks from the first layer into data slices and eliminates duplicate data slices. The third layer stores data slices at an off-site location

In addition, the system 80 includes a multi-processing system running an operating system software and application software programmed to execute programs, wherein each processor when active performs unique data processing functions operationally independent of the other processors. A resource allocation circuit selectively activates the individual processors on a minute time slice basis, where a time slice has approximately the same time duration as the system storage time. The resource allocation circuit includes a priority network that receives real time common resource utilization requests from the processors according to the individual processor needs, assigns a priority rating to the received requests and alters in response thereto the otherwise sequential activation of the processors. Programming execution efficiency of each processor is thereby maximized, and individual processors are concurrently executing their respective programs. The system also provides for the streaming video data to be displayed on the mounted cab terminal and accepts input from the inspector during an inspection as well as the output of recommended remedial actions.

As part of the software, the system 80 allows for the adjustment of each camera's gain, exposure, frame rate and white balance.

A communication system supplies the necessary hardware to interconnect the historical defect data to the system 80. Historical defect data is transmitted to the system 80 for geographic plotting, analyses, and comparative assessment across the communication system.

A display terminal, a speaker, and a digital or mechanical keyboard are also utilized in the real-time feedback of the system 80 and to review the streaming video image, to display AR images of historical defects, playback other stored data (images, reports, etc.), to display and input on interactive forms. If the inspector detects a defect, a tap of the display screen will capture all relevant data associated with the location including a high-resolution segment of images of the preceding 30 seconds through the subsequent 30 seconds as well as the date and time the defect was detected, the GPS referenced location. The inspector may further utilize the keyboard and cursor to add any textual input to the priority segment such as geographic references, milepost locations, defect status, recommended remedial actions, as well as to annotate and overlay the captured image with graphics and/or text. This segment of images and associated data are prioritized for cloud storage and remote viewing in near real-time. The keyboard is also used to prepare track inspection reports.

The system 80 also various image processing functions to permit the analyst to fully view and analyze the identified defect. For instance, it is desirable that the analyst can manipulate the image lighting to brighten a naturally occurring dark image such that the field of view is viewable on the display as if properly lighted.

The system 80 will maintain its own historical defect data at the conclusion of each inspection. This historical defect data will include at least the following: the streaming and still images generated by the video output of the various camera(s); the priority segments and all associated data; the prior set of historical defect data, and a copy of the Track Inspection report. In subsequent inspections on the same length of track, the software of the system 80 de-duplicates the historical defect data to identify newly noted defects and to confirm reporting of prior defects. If past defects were not reported, then all associated images and associated data are prioritized for cloud storage and remote viewing by rail safety management.

Other preferred features of the processing system of the system 80 include control of a graphic display system, preferably through the vision system monitor used by the inspector; recordation, retrieval and analysis in a playback mode of all data collected by the system 80. Advantageously, the countdown timer, will graphically and audible alert the inspector of upcoming historical defects. The display of the system 80 will display the GPS location of an upcoming historical defect, a distance countdown to the upcoming historical defect, a defect ID code as assigned by the rail owner, and the date the historical defect was last observed. Additional information is available for display via software configuration of the system 80 such as the current GPS location of the vehicle 310, the last milepost passed and the distance from the last milepost, the current track number, the posted class of track and posted track speed, the operating speed of the vehicle 310, any exceptions to the posted class of track, etc.

The inspector's primary responsibility is the detection of track anomalies. The inspector receives the digital still and streaming images of the track right-of-way, captured by one of cameras from the system 80. The inspector indicates the detection of defects by one or more keystrokes or mouse clicks as well as a single directional swiping motion across the touch screen display to designate the most common defects. For illustration only a left to right swipe could code the defect as a detective tie; top to bottom swipe signifies ballast issue, etc. Alternatively, the inspector may use an audible input via a keyword or, if utilizing an AR headset, a gaze, gesture or other movement performed by a user within a vicinity of the AR image projection.

The use of single action to capture potential defect data is preferred over multiple buttons or the selection of a specific defect from a plurality of potential defects. The single action recordation of a defect and associated data is highly efficient and not distracting the inspector from conducting the ongoing inspection. Additional inputs can later be added to a segment upon the completion of an inspection or any portion thereof.

At the appropriate time, the inspector may play back the images and data from the entire inspection run or selectively choose to view the captured defects for further analysis. Additionally, when analyzing suspected track anomalies, the inspector will be presented with lists all suspected prior track defects as well as confirmed historical defects. The display will indicate the evaluation status of each defect and allow for display of the image of the noted defect.

The inspector will also have the capability of replaying the entire inspection or selected defect segments at various playback rates to include, but not be limited to, real-time, to a designated mock speed (e.g. 5 miles per hour), and step-frame. Therefore, if the system 80 was utilized to record a run at speeds greater than the inspector's ability to visually detect defects (e.g. greater than 15 miles per hour), the inspector will be able to adjust the playback speed to mimic any desired speed, such as the preferred 5-10 miles per hour and even frame by frame.

If the defect is confirmed, the inspector will indicate this on the display and enter descriptive information about the defect into the system 80. Preferably, a list of the most common track defects will be presented to the inspector for selection and inclusion. In addition, a free-format field for miscellaneous comment input is supplied. This process advantageously minimizes operator input and facilitates easy movement between various displays or windows. If the defect is determined to be invalid, the analyst will indicate this fact on the display. All suspected track defects will be retained in the system, regardless of having been evaluated as confirmed or invalid.

With the foregoing arrangement, the vehicle 310 of the present disclosure permits inspection of railroad track at speeds up to 120 miles per hour. The provision of the system 80 including the creation of video images of the track, storage of the images including anomalies, and manipulation of the stored images to adequately view the anomaly, permits inspection of the track at speeds greater than previously achieved in this type of inspection.

Observed Exceptions

In general, rail and key components requires the determination of an “Exception Type” which is the serviceability necessary to insure the rail's safe and efficient operation. There are four levels of serviceability: (i) operational, (ii) limited operations, (iii) restricted operations, and (iv) out of service.

Anything other than a “satisfactory” condition of serviceability will trigger the software analyzer to apply additional data analysis to follow business rules specific to each serviceability classification. The software will also wirelessly communicate the defects and condition assessment remotely to a control room supervisor with real-time access to the inspector's field of view as well as measurement results, and voice connectivity. The field of view videos and images may be remotely viewed by accessing the device's internal IP address. Alternatively, the user's field of view videos and images captured by the device's integrated camera 202, may be transmitted electronically to the remote control room supervisor as a series of image frames or video. The camera interface device also captures the images provided by the image projector for storage in memory of the computer 200 or a database, including cloud databases.

A “satisfactory” condition of serviceability exists when the track structure is maintained within serviceable tolerance limits. Any identified defects reflect that the inspected asset is not in pristine condition but trains can operate at maximum authorized speed. These conditions may affect ride comfort qualities of the track, should they degrade to a worse condition. Uncorrected defects are recorded and the data will trigger reports for future inspection and/or scheduling future work. Note this condition in the table in inspection reports will be color-coded green.

A “limited operations” condition of serviceability exists when the inspector's measurement exceeds the tolerance limits and the section of track is damaged or worn to the point that the components are no longer in their original condition. This condition is not immediately dangerous or threatening. Such designation alerts to a track condition that affects the ride comfort qualities of the track and that may degrade to a worse condition if left uncorrected. Work programs should be established for the correction of these defects. This condition is a state of caution. It requires de-rating all train traversing that length of track. That is, placing a speed restriction on the section of track affected until the problem is scheduled for repair and repaired. Note this condition in the table in inspection reports will be color-coded yellow.

A “restricted operations” condition of serviceability exists when the inspector's measurement exceeds the tolerance limits and the section of track has failed to an extent that could lead to derailments of rolling stock, and/or damage, and/or injury. Conditions that require inspection by a qualified person within 24 hours of the time of the detection of the condition. Immediately determine whether a slow speed order is necessary and what work is required, base these decisions on findings and other factors, such as the type of defect, the location and permanent speed of the track in question. The inspector, upon determining that a condition of restricted operations exists, should immediately impose the proper slow order, notify his immediate superior of the nature of the defect, and monitor/supervise operations until relieved. Note this condition in the table in inspection reports will be color-coded red.

An “out of service” condition of serviceability exists when the inspector's measurement exceed the tolerance limits and a section of track has deteriorated to the point where no train movement is allowed. This condition has one or more components that have exceeded code red limits.

The inspector or other qualified person(s) detecting such condition should make every effort to correct the condition immediately and must also evaluate whether to allow operations to continue under supervision or to place the track out of service immediately. If operation is allowed to continue, the person(s) making the decision must not leave the scene until relieved or until the defect is repaired. When “walking” trains over such a condition, each train should be stopped short of the defect and the person on the ground should communicate the situation to the train operator. Movements should be made at “Slow Speed with Extreme Caution”; that is, proceeding no faster than 15 mph; prepared to stop at least two car lengths short of a visible object on the roadway; ready to make a fast stop; watching rails and switches for the route and looking for anything on the roadbed that is unsafe to pass. Note this condition in the table in inspection reports will be color-coded black.

Upon completion of an inspection, the disclosed system provides the capability to automatically extract sample set of timestamped defects (i.e. keyhole markup language, also known as .kml) and display those points on a satellite imagery application (i.e. Google Earth) against a survey inspection file detailing the rail's geo-referenced path.

In addition, the disclosed system provides the capability to launch and review a GPS referenced defect by clicking on an icon on the geo-referenced path display (i.e. Google Earth) representing the defect location along the inspection path. The system 80 will start the video streaming a set distance ahead of the geotagged location enabling the inspector to review the defect location and surrounding features.

Therefore, in view of the above, there exists an unfulfilled need for an apparatus and system for providing, among other things, the real-time display of key track components and expedited local and remote access to track data including geometry and historical defect data as an integrated part of rail monitoring and inspection programs

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the particular embodiment disclosed as the best mode contemplated for carrying out this invention, but that the invention will include all embodiments falling within the scope of the claims.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A apparatus to inspect and analyze railroad track and key track components comprising:
an imaging module that collects image data and displays streaming video and key track components, reports and other geographical data;
a data processing module that analyzes defect data;
a mapping sensor that collects data related to the rail, key track components, and user location data;
an image processing module that processes the image data and displays overlaid images onto the camera's field of view;
a database operatively connected to the image processing module that saves the processed image data and provides past measurement and location data to the processing module; and
a software module operatively connected to the database for analyzing the processed data on at least a user device.

2. The apparatus of claim 1, wherein, the imaging module outputs an augmented reality image of known defect data overlaid on a visible length of rail and track components based on the user location data and location data for known defects and track components.

3. The apparatus of claim 1, wherein, the imaging module outputs an augmented reality image of an inspection form which an inspector can complete with audible input, gaze, gestures, or other movement performed by the inspector.

4. The apparatus of claim 1, wherein the software module analyzes various aspects of the railroad track and provides instructional feedback to the user regarding changes to usage conditions and safety of the railway track.

5. The apparatus of claim 1 wherein the software module analyzes the processed data and provides instructional feedback to the inspector regarding changes to usage conditions and safety of the railway track.

6. The apparatus of claim 1, wherein said imaging module, a data processing module, a mapping sensor, an image processing module, a database, and a software module are all incorporated into a wearable device.

7. The apparatus of claim 6, wherein the wearable device displays an augmented reality view of the location of known defects overlaid on a visible length of rail and track components.

8. The apparatus of claim 1, wherein the imaging module comprises at least one wide angle imaging module that displays left and right views of the track.

9. The apparatus of claim 8, wherein the wide angle imaging module is a high resolution spherical camera.

10. The apparatus of claim 8, wherein the wide angle imaging module displays a field of view no less than 170 degrees in the vertical plan and 90 degrees in the horizontal plane.

11. The apparatus of claim 1, wherein imaging module comprises at least one wide angle imaging module and two high definition imaging modules.

12. The apparatus of claim 11, wherein each high definition imaging module is focused on the exterior side of the proximal rail and the interior side of the adjacent rail.

13. The apparatus of claim 11, wherein each high definition imaging module is mounted above each end of a high rail's front bumper extending no less than 4.5 inches past the exterior of each rail and raised 48 inches above the track.

14. A method of inspecting railroad track at speeds up to 120 miles per hour, the method comprising:
capturing video images of railroad track and key track components with an imaging module's frame rate automatically adjusted based upon the operating speed of the train;
storage of the video images and key track components in a database;
processing the video images to overlay known defect data on the track and key track components;
processing the video images to artificially reduce the speed of the images to 15 miles per hour; and
viewing the artificially speed-reduced video images to conduct a track inspection.

15. The method of claim 13 wherein the imaging module automatically initiates capturing video images of railroad track and key track components upon initial movement of the high rail car.

16. The method of claim 13 wherein the imaging module automatically terminates capturing video images of railroad track and key track components upon the stoppage of movement of the high rail car.

17. The method of claim 13 wherein upon the initiation of the imaging module, a check is automatically performed to confirm the high rail inspection is taking place at the proper location.

18. A method of alerting a railroad track inspector of identified defects, the method comprising:
displaying a countdown indicator on a graphical user interface for upcoming defects based on a preloaded set of defect data;
an auditory tone to audibly alert the track inspector of an upcoming defect based on a preloaded set of defect data; and
the preloaded set of defect data includes one or more of the following: (i) geometry car survey exceptions; (ii) rail wear exceptions; (iii) autonomous ride quality measured defects; (iv) track loading vehicle defects; (vi) ground penetrating radar; and (v) exceptions from prior visual inspections.

19. The method of claim 14 wherein the countdown indicator is a reverse distance timer.

20. The method of claim 14 wherein the countdown indicator is a time to defect timer.
